(19) United States
(12) Patent Application Publication
(10) Pub. No.: US 2011/0027522 A1
(43) Pub. Date: Feb. 3, 2011

(54) RESIN MOLDED COMPONENT FOR VEHICLE

(75) Inventor: Ryuji KUBO, Kawasaki-shi (JP)

Correspondence Address: MOTS LAW, PLLC, 1629 K STREET N.W., SUITE 602, WASHINGTON, DC, 20006-1635, US

(73) Assignee: FALTEC CO., LTD., Kawasaki-shi (JP)

(21) Appl. No.: 12/846,592

(22) Filed: Jul. 29, 2010

(30) Foreign Application Priority Data
Jul. 30, 2009 (JP) 2009-177283

(51) Int. Cl. B32B 3/06

(52) U.S. Cl. 428/99

(57) ABSTRACT

A sill cover includes an elongated sill cover main body, a step portion, hinges and attachments. The sill cover main body includes a bottom surface portion formed in a curved surface shape along a longitudinal direction of the sill cover main body. The step portion is provided to the bottom surface portion along a longitudinal direction of the bottom surface portion. The hinges are foldably provided to hinge support ends of the step portion. The attachments are connected to the hinges and shift to vehicle mounting positions according to folding of the hinges. A height of the step portion is variable along a longitudinal direction of the step portion, so that the hinge support ends are linearly arranged along the longitudinal direction of the hinge support ends.

### CROSS REFERENCE TO RELATED APPLICATION

This application claims benefit of priority under 35 U.S.C. §119 to Japanese Patent Application No. 2009-177283, filed on Jul. 30, 2009, the entire contents of which are incorporated by reference herein.

### BACKGROUND OF THE INVENTION

1. Field of the Invention

The present invention relates to a resin molded component for a vehicle to be mounted on the vehicle as an exterior part of the vehicle.

2. Description of the Related Art

For example, a sill cover, which is an elongated resin molded component for a vehicle, is mounted on a bottom side of a vehicle door to protect a vehicle body. Conventional sill covers are proposed by Patent Documents 1 (Japanese Published Unexamined Application No. 2005-59811) and 2 (Japanese Published Unexamined Application No. 2000-16342). A conventional sill cover includes a sill cover main body and an attachment connected to a bottom end of the sill cover main body via a hinge. The sill cover main body and the attachment are integrally formed by injection molding.

The sill cover is mounted on a vehicle by causing the attachment to shift from an injection molding position to a vehicle mounting position with respect to the sill cover main body according to folding of the hinge. Thus, the sill cover main body and the attachment are integrally injection-molded, which reduces the number of components, a man-hour cost of assembly and the like.

A configuration of sill cover is determined by various conditions (e.g., air resistance and design). For example, a bottom surface portion of the sill cover is formed into a curved surface shape along a longitudinal direction thereof.

However, if the attachment is attached on a curved bottom surface portion of the sill cover main body via the hinge, a center region (rotation axis) of the hinge is formed into a curved surface shape along the longitudinal direction of the sill cover. This makes folding of the attachment along the center region of the hinge difficult and deteriorates assembly accuracy of the sill cover largely.

### SUMMARY OF THE INVENTION

The present invention is invented in order to solve the above-described problem, and has an object to provide a resin molded component for a vehicle that allows an attachment of the resin molded component to be easily folded along a center region of a hinge and allows the resin molded component to have high assembly accuracy, even if a camber surface portion where the hinge is to be provided is curved along a longitudinal direction of the resin molded component.

In order to achieve the above object, the present invention provides a resin molded component for a vehicle comprising: an elongated molded component main body that includes a camber surface portion formed in a curved surface shape along a longitudinal direction of the molded component main body; a ridge that is provided to the camber surface portion along a longitudinal direction of the camber surface portion; a hinge that is foldably provided to a hinge support end of the ridge; and an attachment that is connected to the hinge and shifts to a vehicle mounting position according to folding of the hinge, wherein a height of the ridge is variable along a longitudinal direction of the ridge so that the hinge support end is linearly arranged along the longitudinal direction of the hinge support end.

According to the present invention, although the camber surface portion of the molded component main body is curved along the longitudinal direction of the molded component main body, the center region (rotation axis) of hinge is linearly arranged along a longitudinal direction of the hinge because the hinge is provided to the camber surface portion via the ridge of which the height is variable along the longitudinal direction of the ridge. This allows the attachment to be easily folded along the center region of hinge and allows the sill cover to have high assembly accuracy even if the camber surface portion is curved at a side where the hinge is provided along the longitudinal direction of the molded component main body.

In a preferred embodiment of the present invention, the ridge has a thickness which is set to be larger than a thickness of the molded component main body.

According to this embodiment, this allows the attachment to be easily folded along the center region of hinge and allows the sill cover to have high assembly accuracy because the hinge is supported by the thicker ridge.

### BRIEF DESCRIPTION OF THE DRAWINGS

FIG. 1 is a schematic perspective view of a vehicle according to an exemplary embodiment of the present invention.

FIG. 2 is a side view of a sill cover where attachments are in injection molding positions according to the exemplary embodiment of the present invention.

FIG. 3 is a perspective view of the sill cover viewed from an inner surface side thereof where the attachments are in vehicle mounting positions according to the exemplary embodiment of the present invention.

FIG. 4 is a perspective view of the sill cover viewed from the inner surface side thereof where the attachments are in the injection molding positions according to the exemplary embodiment of the present invention.

FIG. 5 is a perspective view of the sill cover viewed from an outer surface side thereof where the attachments are in the vehicle mounting positions according to the exemplary embodiment of the present invention.

FIG. 6 is a perspective view of the sill cover viewed from the outer surface side thereof where the attachments are in the injection molding positions according to the exemplary embodiment of the present invention.

FIG. 7 is an enlarged view of a “P” area shown in FIG. 6.

FIG. 8 is a cross-sectional view due to a line A-A shown in FIG. 7.

FIG. 9 is a cross-sectional view due to a line B-B shown in FIG. 7.

FIG. 10 is a cross-sectional view due to a line C-C shown in FIG. 7.

FIG. 11 is a cross-sectional view that illustrates a vehicle mounting state at a sill cover main body side according to the exemplary embodiment of the present invention.

FIG. 12 is a cross-sectional view that illustrates a vehicle mounting state at an attachment side according to the exemplary embodiment of the present invention.

### DESCRIPTION OF THE EMBODIMENTS

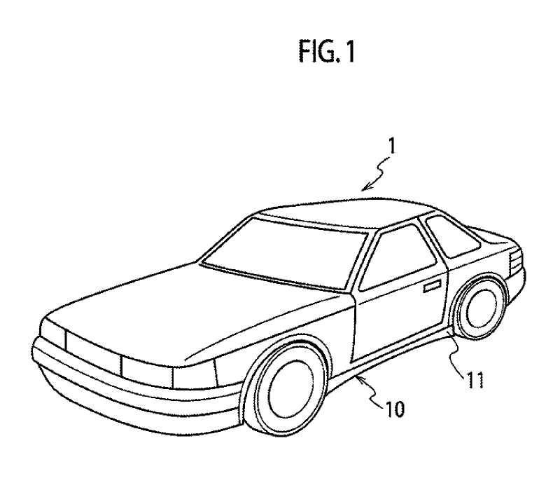

An exemplary embodiment of the present invention will be described below, with reference to FIGS. 1 to 12.

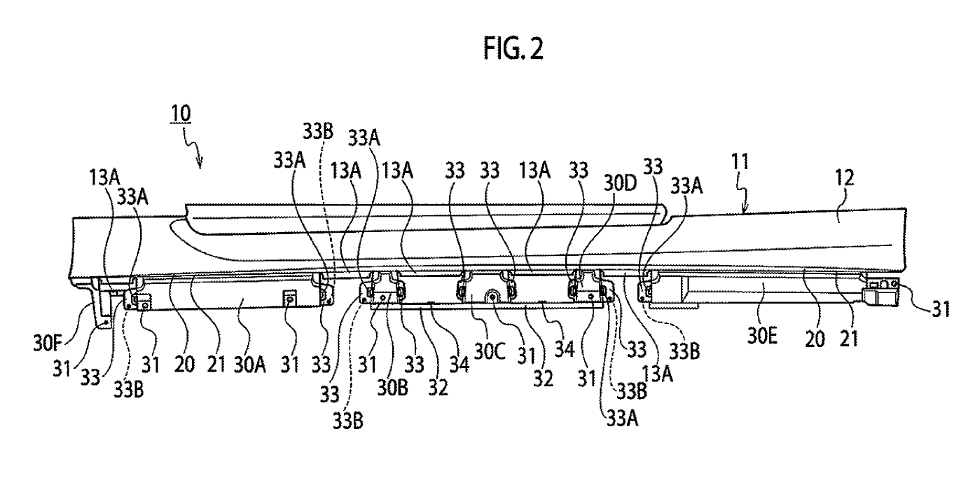

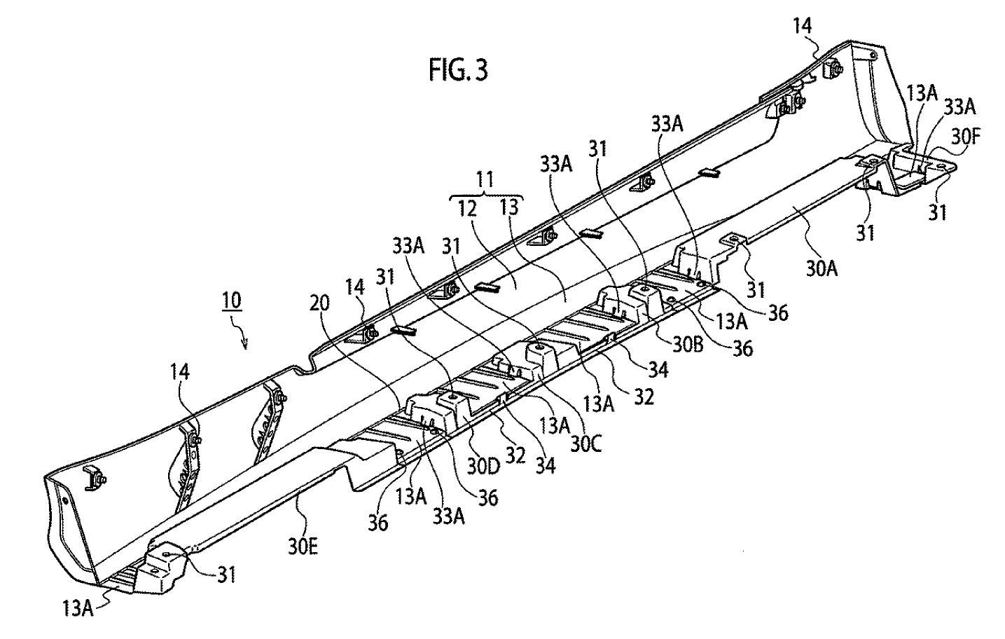

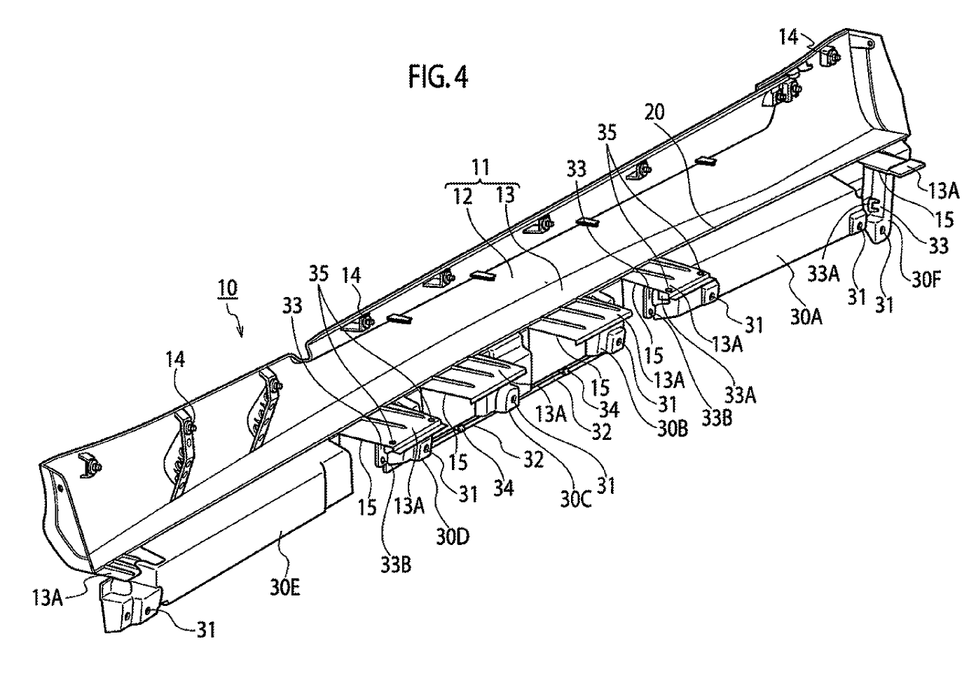

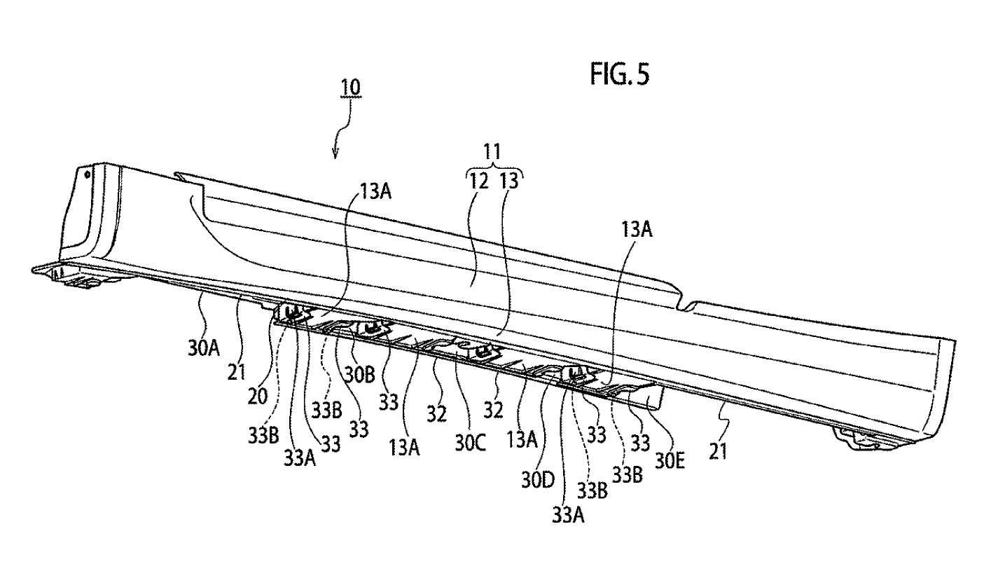

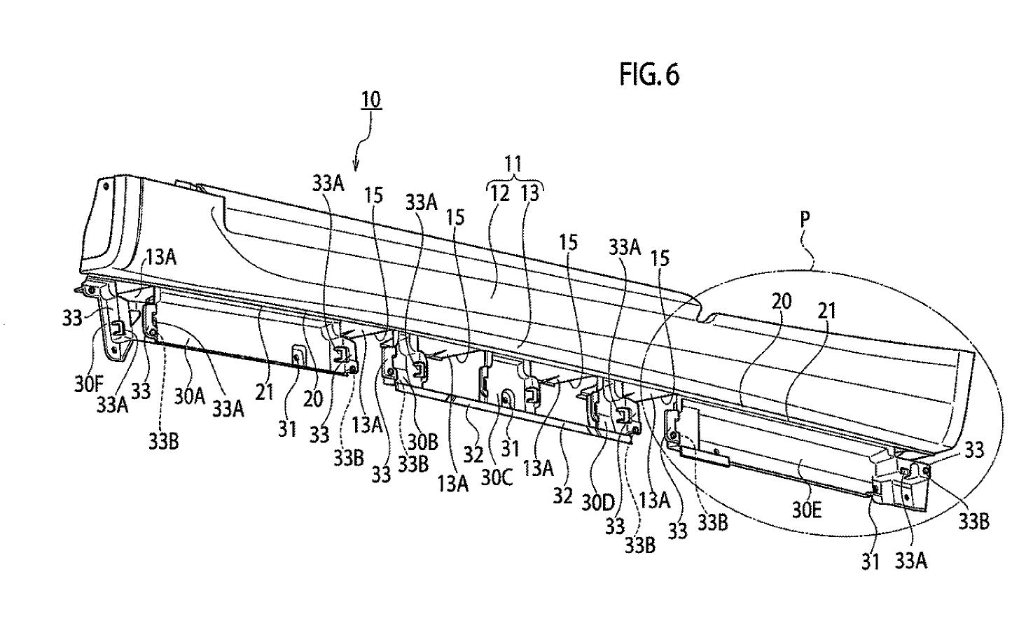

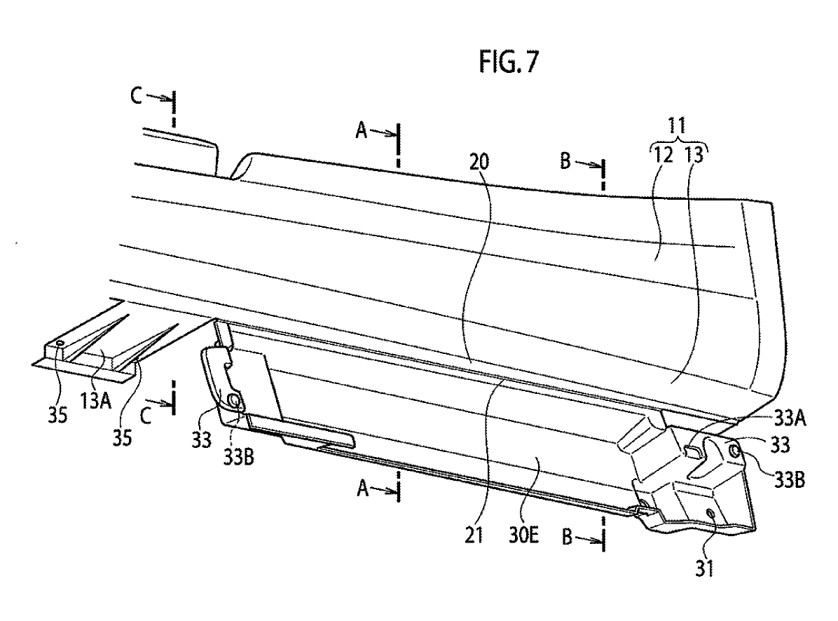

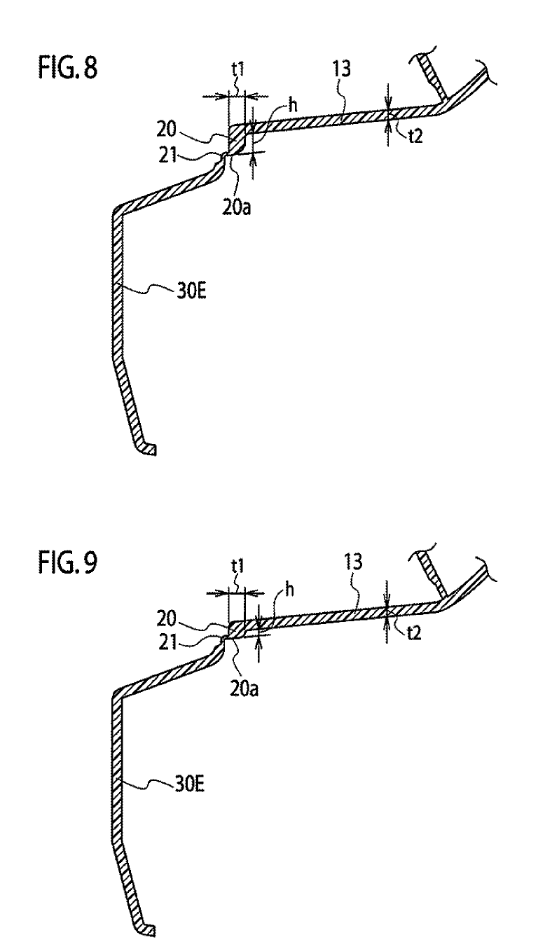

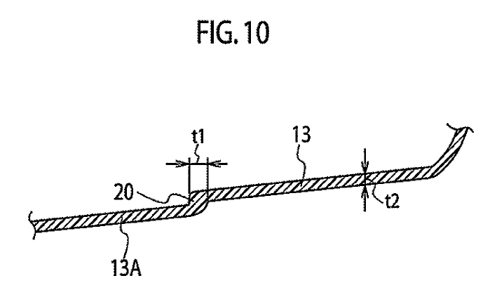

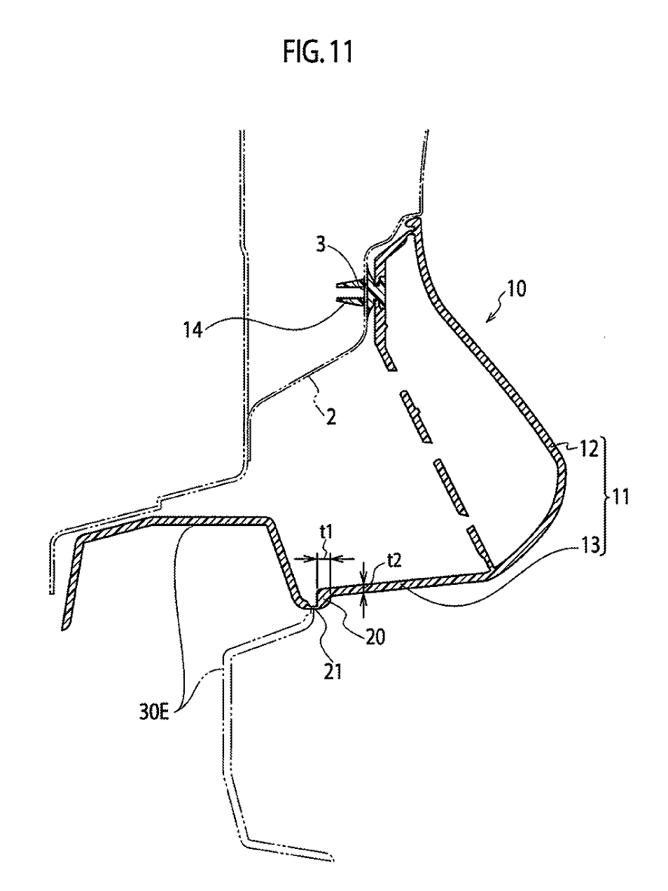

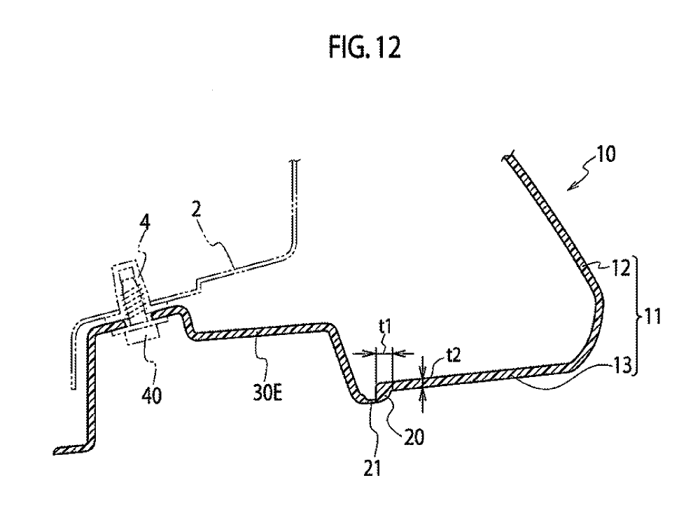

FIG. 1 is a schematic perspective view of a vehicle 1. FIG. 2 is a side view of a sill cover 10 where attachments 30A to 30F are in injection molding positions. FIG. 3 is a perspective view of the sill cover 10 viewed from an inner surface side thereof where the attachments 30A to 30F are in vehicle mounting positions. FIG. 4 is a perspective view of the sill cover 10 viewed from the inner surface side thereof where the attachments 30A to 30F are in the injection molding positions. FIG. 5 is a perspective view of the sill cover 10 viewed from an outer surface side thereof where the attachments 30A to 30F are in the vehicle mounting positions. FIG. 6 is a perspective view of the sill cover 10 viewed from the outer surface side thereof where the attachments 30A to 30F are in the injection molding positions. FIG. 7 is an enlarged view of a “P” area shown in FIG. 6. FIG. 8 is a cross-sectional view due to a line A-A shown in FIG. 7. FIG. 9 is a cross-sectional view due to a line B-B shown in FIG. 7. FIG. 10 is a cross-sectional view due to a line C-C shown in FIG. 7. FIG. 11 is a cross-sectional view that illustrates a vehicle mounting state at a sill cover main body side. FIG. 12 is a cross-sectional view that illustrates a vehicle mounting state at an attachment side.

As shown in FIG. 1, the sill cover 10, which is an elongated resin molded component for a vehicle, is mounted on a bottom side of a door of the vehicle 1 to protect a vehicle body.

As shown in FIGS. 2 to 7, the sill cover 10 includes a sill cover main body 11 that is an elongated molded component main body, a step portion 20 that is a ridge provided to the sill cover main body 11, hinges 21 that are foldably provided to the step portion 20, and the attachments 30A to 30F that are connected to the step portion 20 via the hinges 21. Under a situation where the attachments 30A to 30F are in injection molding positions (positions shown in FIGS. 4 and 6), the sill cover 10 is made by injection-molding synthetic resin material such as polypropylene integrally.

The sill cover main body 11 includes a side surface portion 12 that extends in a longitudinal direction of the sill cover main body 11, and a bottom surface portion 13 that is a camber surface portion protruded in an in-vehicle direction from a lower end of the side surface portion 12. A plurality of clip portions 14 is provided on an inner surface side of the side surface portion 12 in place.

The bottom surface portion 13 is formed in a curved surface shape so that the sill cover 10 looks like it becomes narrower in the center thereof in a vehicle mounting state, in order to meet requests reduction of air resistance and exterior design. More specifically, when the bottom surface portion 13 is viewed from a vehicle side in the vehicle mountain state, the center of the bottom surface portion 13 is most highly-placed and the bottom surface portion 13 is gradually and gently lowly-placed as progressing from the center to both ends thereof.

The step portion 20 is provided over the whole area in a longitudinal direction of the bottom surface portion 13. At a distal end side of the step portion 20, five cut portions 15 are intermittently formed in a longitudinal direction of the step portion 20. Six extended bottom surface portions 13A extend from the bottom surface portion 13 via the step portion 20. Under this configuration, at the distal end side of the step portion 20, the five cut portions 15 and the six extended bottom surface portions 13A are alternately arranged along the longitudinal direction of the step portion 20. The step portion 20 includes hinge support ends 20a that respectively supports the hinges 21.

As shown in FIGS. 8 and 9, a height “h” of the step portion 20 is varied, according to a position in the longitudinal direction of the step portion 20 in an area where each cut portion 15 is formed, so that lowermost side surfaces of the hinge support ends 20a are located on one plane. Since the hinges 21 are respectively supported by the hinge support ends 20a on the lowermost side surfaces of the hinge support ends 20a, center regions (rotation axes) of the hinges 21 are linearly arranged along a longitudinal direction of the sill cover 10 at positions lower than the bottom surface portion 13 by one step due to the step portion 20. As shown in FIG. 10, in order to retain continuity of the step portion 20, a height “h” of the step portion 20 is varied according to a position in the longitudinal direction of the step portion 20 in an area where each extended bottom surface portion 13A is formed. Thereby, the extended bottom surface portions 13A are linearly arranged along the longitudinal direction of the sill cover 10 at positions lower than the bottom surface portion 13 by one step due to the step portion 20.

A thickness “t1” of step portion 20 is set to be larger than a thickness “t2” of the sill cover main body 11 (t2<t1).

Two engagement holes 35 are formed on each of two extended bottom surfaces portions 13A which are respectively located between the attachments 30A and 30B and between the attachments 30D and 30E.

The attachments 30A to 30F are respectively connected to the hinge support ends 20a of the step portion 20, which are located at end portions of the cut portions 15, via the hinges 21. One attachment hole 31 is formed on each of the attachments 30B to 30F. Two attachment holes 31 are formed on the attachment 30A.

Each of the attachments 30B, 30C and 30D, which are located between the attachments 30A and 30E, is set to be smaller than each of the attachments 30A and 30E in width. The attachments 30B, 30C and 30D are linked to one another via a linking portion 32. Therefore, the linking portion 32 allows the attachments 30B, 30C and 30D to shift from the injection molding positions to the vehicle mounting positions in an integrated manner.

Two engagement portions 33 are provided to each of the attachments 30A to 30E. One engagement portion 33 is provided to the attachment 30F. When the attachments 30A to 30F are in the vehicle mounting positions, each engagement portion 33 is engaged to an end edge of each corresponding extended bottom surface portion 13A. Each of two engagement portions 33 of the attachment 30A, one engagement portion 33 of the attachment 30B, one engagement portion 33 of the attachment 30D, and two engagement portions 33 of the attachment 30E includes an engagement claw 33A and an engagement hole 33B. Each of the other engagement portion 33 of the attachment 30B, two engagement portions 33 of the attachment 30C, the other engagement portion 33 of the attachment 30C and one engagement portion 33 of the attachment 30F includes only an engagement claw 33A. Two engagement portions 34 are provided to the linking portion 32. When the attachments 30A to 30F are in the vehicle mounting positions, two engagement portions 34 are respectively engaged to end edges of two extended bottom surface portions 13A located between the attachments 30B and 30C and between the attachments 30C and 30D.

Next, proceeding for mounting the sill cover 10 to the vehicle body will be described.

In the sill cover 10 including the attachments 30A to 30F formed by injection-molding in the injection molding positions shown in FIGS. 4 and 6, each of the attachments 30A to 30F is folded with respect to the sill cover main body 11 using each corresponding hinge 21 to shift from the injection molding position shown in FIGS. 4 and 6 into the vehicle mounting position shown in FIGS. 3 and 5. Then, each engagement portion 33 and each engagement portion 34 are engaged to an end edge of each corresponding extended bottom surface portion 13A. Thereby, the attachments 30A to 30F are held in the vehicle mounting positions shown in FIGS. 3 and 5 against elastic restoring force of the hinges 21. The attachments 30A to 30F held in the vehicle mounting positions are fixed to the extended bottom surface portions 13A by screwing screws 36 into the engagement holes 33B and 35.

The sill cover 10 in which the attachments 30A to 30F are in the vehicle mounting positions shown in FIGS. 3 and 5 is located in a mounting position at the bottom side of a door of a vehicle body 2. Then, as shown in FIG. 11, each clip portion 14 provided on an inner surface of the sill cover main body 11 is mounted into each clip engagement hole 3 of the vehicle body 2. Also, as shown in FIG. 12, tapping screws 40 are inserted into the attachment holes 31 of the attachments 30A to 30F to be mounted into grommets 4 of the vehicle body 2. Thereby, the sill cover 10 is mounted to the vehicle body 2.

As described above, the sill cover 10 includes the elongated sill cover main body 11, the step portion 20, the hinges 21 and the attachments 30A to 30F. The sill cover main body 11 includes the bottom surface portion 13 formed in a curved surface shape along a longitudinal direction of the sill cover main body 11. The step portion 20 is provided to the bottom surface portion 13 along a longitudinal direction of the bottom surface portion 13. The hinges 21 are foldably provided to the hinge support ends 20a of the step portion 20. The attachments 30A to 30F are connected to the hinges 21 and shift to the vehicle mounting positions according to folding of the hinges 21. The height of the step portion 20 is variable along a longitudinal direction of the step portion 20, so that the hinge support ends 20a are linearly arranged along the longitudinal direction of the hinge support ends 20a.

Thus, although the bottom surface portion 13 of the sill cover main body 11 is curved along the longitudinal direction of the sill cover 10, the center regions (rotation axes) of hinges 21 are linearly arranged along the longitudinal direction of the sill cover 10 because the hinges 21 are provided to the bottom surface portion 13 via the step portion 20 of which the height is variable along the longitudinal direction of the step portion 20. This allows the attachments 30A to 30F to be easily folded along the center regions of hinges 21 and allows the sill cover 10 to have high assembly accuracy even if the bottom surface portion 13 is curved at a side where the hinges 21 are provided along the longitudinal direction of the sill cover 10.

The thickness “t1” of step portion 20 is set to be larger than the thickness “t2” of the sill cover main body 11. Therefore, this allows the attachments 30A to 30F to be easily folded along the center regions of hinges 21 and allows the sill cover 10 to have high assembly accuracy because the hinges 21 are supported by the thicker step portion 20.

Some of the engagement portions 33 are engaged to corresponding extended bottom surface portions 13A by screwing the screws 36 into the engagement holes 33B of the some of engagement portions 33 and the engagement holes 35 of the corresponding extended bottom surface portions 13A. This prevents the sill cover 10 from unfastening after the sill cover 10 is mounted to the vehicle body 2.

In this exemplary embodiment, although the sill cover 10 is cited as an example of a resin molded component for a vehicle, even if another member is cited as another example of the resin molded component, the present invention may be applied to the another example.

In this exemplary embodiment, although the camper surface portion is the bottom surface portion 13 of the sill cover main body 11, even if the camper surface portion is a portion other than the bottom surface portion 13, the present invention may be applied to it.

In this exemplary embodiment, although the step portion 20, which is the ridge, is provided over the whole area in the longitudinal direction of the bottom surface portion 13, the step portion 20 may be intermittently provided in only areas where the hinges 21 are to be provided. However, in the case where the step portion 20 is provided over the whole area in the longitudinal direction of the bottom surface portion 13, the strength of step portion 20 increases, which increases that of the sill cover 10. In addition, it is a preferable design.

In this exemplary embodiment, although the sill cover main body 11 is mounted to the vehicle body 2 using the clip portions 14, the present invention is not limited to it. The sill cover main body 11 may be mounted to the vehicle body 2 using another adequate member.

What is claimed is:

1. A resin molded component for a vehicle comprising:
an elongated molded component main body that includes a camber surface portion formed in a curved surface shape along a longitudinal direction of the molded component main body;
a ridge that is provided to the camber surface portion along a longitudinal direction of the camber surface portion;
a hinge that is foldably provided to a hinge support end of the ridge; and
an attachment that is connected to the hinge and shifts to a vehicle mounting position according to folding of the hinge,
wherein a height of the ridge is variable along a longitudinal direction of the ridge so that the hinge support end is linearly arranged along the longitudinal direction of the hinge support end.

2. The resin molded component for a vehicle according to claim 1, wherein the ridge has a thickness which is set to be larger than a thickness of the molded component main body.
